(19) United States
(12) Patent Application Publication
(10) Pub. No.: US 2023/0350430 A1
(43) Pub. Date: Nov. 2, 2023

(54) Aircraft, Aircraft Control Method, and Computer Readable Storage Medium

(71) Applicant: HANWANG TECHNOLOGY CO., LTD., Beijing (CN)

(72) Inventors: Jing Liu, Beijing (CN); Yingjian Liu, Beijing (CN)

(21) Appl. No.: 17/997,901

(22) PCT Filed: Feb. 2, 2021
(86) PCT No.: PCT/CN2021/074842

§ 371 Date: Nov. 3, 2022

(30) Foreign Application Priority Data
May 6, 2020 (CN) 202010380801.0

(51) Int. Cl. G05D 1/08; G05D 1/06

(52) U.S. Cl. CPC G05D 1/0816; G05D 1/0623; B64C 13/34

(57) ABSTRACT

An aircraft, an aircraft control method, and a computer readable storage medium. An aircraft including: a gyroscope used for measuring the angular velocity of the yaw angle of the aircraft; a processor used for determining a yaw control signal of the aircraft on the basis of the angular velocity of the yaw angle without considering the acceleration of the aircraft; and an execution mechanism used for adjusting the flight of the aircraft on the basis of the yaw control signal.

### TECHNICAL FIELD

The present disclosure relates to a field of flight technology, in particular to an aircraft, a control method for the aircraft and a computer-readable storage medium.

### BACKGROUND

In recent years, aircrafts are more and more popular. Existing aircrafts are mainly divided into winged aircrafts and wingless aircrafts. Winged aircrafts include fixed-wing aircrafts such as airplanes and gliders and moving-wing aircrafts such as rotary wing aircrafts and flapping-wing aircrafts. It is crucial for the popularization of aircrafts that an aircraft, especially a winged aircraft, can fly stably. Therefore, how to consider characteristics of the aircraft itself to achieve a stable flight for the aircraft is one of the urgent problems to be solved in the art.

### SUMMARY

Based on the above, the present disclosure provides an aircraft capable of achieving a stable flight, a control method for the aircraft, a control device of the aircraft and a computer-readable storage medium.

In an aspect of the present disclosure, the present disclosure provides an aircraft, comprising: a gyroscope for measuring an angular velocity of a yaw angle for the aircraft; a processor for determining a yaw control signal for the aircraft without considering an acceleration of the aircraft based on the angular velocity of the yaw angle; and an execution mechanism for adjusting a flight of the aircraft based on the yaw control signal.

In another aspect of the present disclosure, the present disclosure provides a control method for an aircraft, comprising: acquiring an angular velocity of a yaw angle for the aircraft; determining a yaw control signal for the aircraft without considering an acceleration of the aircraft, based on the angular velocity of the yaw angle; and adjusting a flight of the aircraft, based on the yaw control signal.

In yet another aspect of the present disclosure, the present disclosure provides a control device of an aircraft, comprising a gyroscope, a processor and an execution mechanism, wherein the gyroscope is used for measuring an angular velocity of a yaw angle, the processor is used for implementing the control method for the aircraft according to embodiments of the present disclosure, and the execution mechanism is used for adjusting a flight of the aircraft based on control information generated by the processor.

In yet another aspect of the present disclosure, the present disclosure provides a control device of an aircraft, comprising: a processor; a memory; and computer program instructions stored in the memory, the computer program instructions, when being executed by the processor, performing steps of a control method for the aircraft according to embodiments of the present disclosure.

In yet another aspect of the present disclosure, the present disclosure provides a computer-readable storage medium storing a computer program thereon which, when being executed by a processor, implements a control method for an aircraft according to embodiments of the present disclosure.

In addition, the present disclosure further provides a computer program product for controlling a flight of an aircraft.

### BRIEF DESCRIPTION OF DRAWINGS

The above and other objects, features and advantages of the present disclosure will become more apparent by describing embodiments of the present disclosure in more detail in conjunction with accompanying drawings. The drawings are used to provide a further understanding of the embodiments of the present disclosure and constitute a part of the specification. The drawings together with the embodiments of the present disclosure are used to explain the present disclosure, but do not constitute a limitation on the present disclosure. In the drawings, unless otherwise explicitly indicated, the same reference numerals refer to the same components, steps or elements. In the accompanying drawings,

FIG. 1 shows definitions for a roll axis, a pitch axis and a yaw axis according to an embodiment of the present disclosure;

FIG. 2 shows an example flight trajectory according to an embodiment of the present disclosure;

FIG. 3 is a schematic diagram for an aircraft according to an embodiment of the present disclosure;

FIG. 4A is a front view of an exemplary mounting position of a gyroscope on an aircraft according to an embodiment of the present disclosure;

FIG. 4B is a side view of an exemplary mounting position of a gyroscope on an aircraft according to an embodiment of the present disclosure;

FIG. 5 is an example flowchart for a control method for an aircraft according to an embodiment of the present disclosure;

FIG. 6 is an example flowchart further illustrating step S510 in FIG. 5 of determining a yaw control signal for the aircraft without considering an acceleration of the aircraft based on the angular velocity of the yaw angle;

FIG. 7 is an example flowchart further illustrating step S512 in FIG. 6 of determining a deflection angle for the aircraft from a desired yaw direction without considering the acceleration of the aircraft based on the angular velocity of the yaw angle;

FIG. 8 is another example flowchart for a control method for an aircraft according to an embodiment of the present disclosure;

FIG. 9 is yet another example flowchart for a control method for an aircraft according to an embodiment of the present disclosure;

FIG. 10 is an example flowchart further illustrating step S920 in FIG. 9 of determining an altitude control signal for the aircraft without considering the acceleration of the aircraft based on both an altitude parameter and the angular velocity of the pitch angle;

FIG. 11 is an example flowchart further illustrating step S928 in FIG. 10 of determining the altitude control signal for the aircraft based on the difference and the pitch angle;

FIG. 12 shows an example flight trajectory of an aircraft under a control of a control method for the aircraft according to an embodiment of the present disclosure;

FIG. 13 shows another example flight trajectory of an aircraft under a control of a control method for the aircraft according to an embodiment of the present disclosure;

FIG. 14 is an example block diagram for a control device of an aircraft according to an embodiment of the present disclosure; and

FIG. 15 is another example block diagram for a control device of an aircraft according to an embodiment of the present disclosure.

### DETAILED DESCRIPTION

The technical solution of the present disclosure will be clearly and completely described below in conjunction with accompanying drawings. Obviously, the described embodiments are part of embodiments of the present disclosure, but not all of them. Based on the embodiments in the present disclosure, all other embodiments obtained by ordinary skilled in the art without making any creative efforts fall within the scope of protection of the present disclosure.

In the description of the present disclosure, it should be noted that orientations or positional relationships indicated by terms such as “center”, “upper”, “lower”, “left”, “right”, “vertical”, “horizontal”, “inside” and “outside” are based on orientations or positional relationships shown in the drawings, only for the convenience of describing the present disclosure and simplifying the description, instead of indicating or implying the indicated device or element must have a particular orientation. In addition, terms such as “first”, “second” and “third” are only for descriptive purposes, whereas cannot be understood as indicating or implying relative importance. Likewise, words like “a”, “an” or “the” do not represent a quantity limit, but represent an existence of at least one. Words like “include” or “comprise” mean that an element or an object in front of the said word encompasses those ones listed following the said word and their equivalents, without excluding other elements or objects. Words like “connect” or “link” are not limited to physical or mechanical connections, but may include electrical connections, whether direct or indirect.

In the description of the present disclosure, it should be noted that, unless otherwise explicitly specified and limited, terms such as “mount”, “link” and “connect” should be understood in a broad sense. For example, such terms may refer to being fixedly connected, or detachably connected, or integrally connected; may refer to being mechanically connected, or electrically connected; may refer to being directly connected, or indirectly connected via an intermediate medium, or internally connected inside two elements. For ordinary skilled in the art, the specific meanings of the above terms in the present disclosure may be understood on a case-by-case basis.

In addition, technical features involved in different embodiments of the present disclosure described below may be combined with each other as long as no conflicts occurs therebetween.

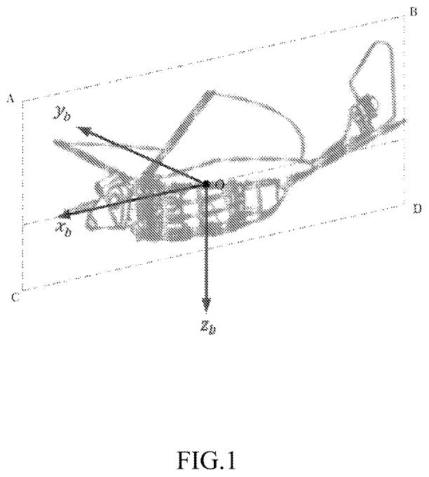

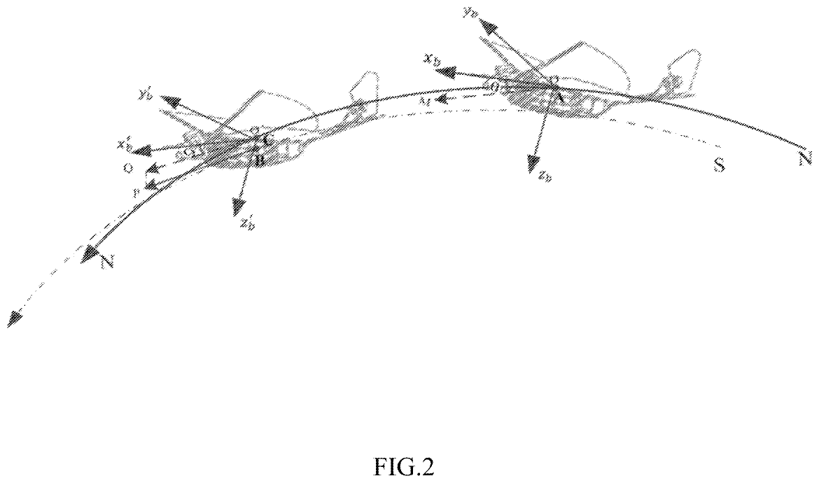

In order for a better understanding of embodiments of the present disclosure, some terms used in the present disclosure will be explained in conjunction with FIGS. 1 and 2 before describing the embodiments of the present disclosure in detail.

FIG. 1 shows a roll axis, a pitch axis and a yaw axis according to an embodiment of the present disclosure. In the present disclosure, as shown in FIG. 1, it is assumed that: the roll axis (i.e., axis x_{b} in FIG. 1) is an axis pointing to a nose of an aircraft with the centroid of the aircraft (i.e., point O in FIG. 1) as the origin; the pitch axis (i.e. axis z_{b} in FIG. 1) is an axis on a symmetry plane of the aircraft and pointing down the aircraft with the centroid of the aircraft as the origin, where the symmetry plane of the aircraft is an plane with respect to which left and right sides of the aircraft are symmetrical (i.e. plane ABCD in FIG. 1); the yaw axis (i.e., axis y_{b} in FIG. 1) is an axis perpendicular to a plane (i.e., a plane Ox_{b}z_{b} in FIG. 1) determined by the roll axis and the pitch axis and pointing to the right side of the aircraft with the centroid of the aircraft as the origin. In other words, it is assumed that, in a case that the bottom of a fuselage of an aircraft is facing down and a nose of the aircraft is facing away from the operator, the roll axis is an axis pointing from a tail of the aircraft to the nose, the pitch axis is an axis pointing from the upper part of the fuselage to the lower part, and the yaw axis is an axis pointing from the left side of the fuselage to the right side.

FIG. 2 shows an example flight trajectory according to an embodiment of the present disclosure. As shown in FIG. 2, it is assumed that a desired flight trajectory of an aircraft in the horizontal plane is SS, and an actual flight trajectory of the aircraft is NN. It is assumed that A is a position at which the aircraft is at time t−1, B is a position at which the aircraft should be at time t, and C is an actual position at which the aircraft is at time t.

Expected yaw direction: a direction on the horizontal plane towards which the aircraft should face at time t in order to make an aircraft fly along a desired flight trajectory, e.g., direction BP in FIG. 2.

Yaw angle (i.e., Ay as described below) and pitch angle (i.e., Az as described below): for the convenience of describing the yaw angle, assuming that the direction of a pitch axis (i.e., axis z_{b} in FIG. 1) of an aircraft does not change for a predetermined period from t−1 to t, the yaw angle is an angle that a yaw axis (i.e., axis y_{b} in FIG. 1) of the aircraft rotates around the pitch axis of time t−1 for the predetermined period, i.e., an integral of an angular velocity of the yaw angle of the aircraft for the predetermined period, reflecting an angle that the aircraft actually rotates around the pitch axis of time t−1 for the predetermined period in the body coordinate system. For the convenience of describing the pitch angle, assuming that the direction of the yaw axis (i.e. axis y_{b} in FIG. 1) of the aircraft does not change for a predetermined period from t−1 to t, the pitch angle is an angle that the pitch axis (i.e., axis z_{b} in FIG. 1) of the aircraft rotates around the yaw axis of time t−1 for the predetermined period, i.e., an integral of the angular velocity of the pitch angle of the aircraft for the predetermined period, reflecting an angle that the aircraft actually rotates around the yaw axis of time t−1 for the predetermined period in the body coordinate system.

Desired yaw angle (i.e., θ as described below): an included angle formed by the roll axis (i.e. the direction of the fuselage) of the aircraft of time t−1 and a line by projecting the desired yaw direction of time t onto the plane determined by the roll axis and the yaw axis in the body coordinate system of time t−1, i.e., the included angle θ between OM and x_{b} in FIG. 2. The desired yaw angle reflects an angle that the aircraft should rotate around the pitch axis of time t−1 for a predetermined period in the body coordinate system in order to be able to fly along the desired flight trajectory at time t.

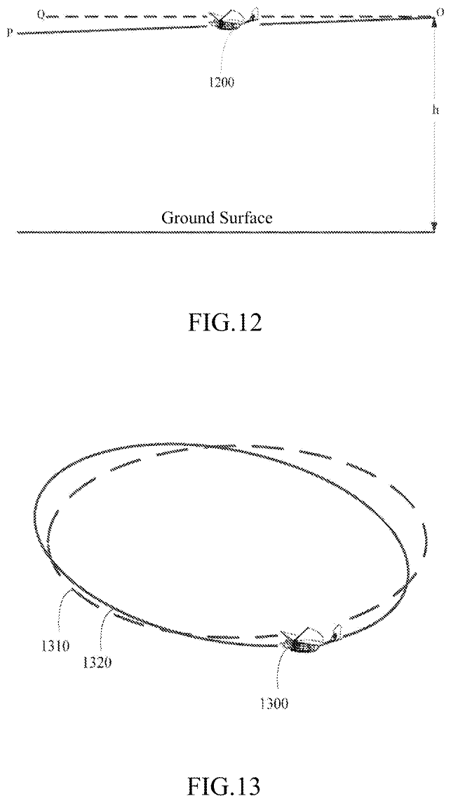

In the present disclosure, different desired flights may be implemented by setting different θ. For example, when θ=0, the aircraft flies in a straight line, as shown in FIG. 12. When θ is not equal to 0, the aircraft flies along a curve, as shown in FIG. 13 for example. In this case, the desired yaw angle is positive when the roll axis is on the outside (e.g., the right side) of the projection; the desired yaw angle is negative when the roll axis is on the inner side (e.g., the left side) of the projection. It should be understood that the foregoing determination as to whether the desired yaw angle is positive or negative is merely an example, but not a limitation to the present disclosure.

Deflection angle for the aircraft from the desired yaw direction (i.e., Cy as described below): for the predetermined period, a difference between the angle (i.e., yaw angle) that the aircraft actually rotates around the pitch axis of time t−1 and the desired yaw angle, that is, an included angle formed by the roll axis (i.e. the direction of the fuselage) of the aircraft of time t and a line by projecting the desired yaw direction of time t onto the plane determined by the roll axis and the yaw axis in the body coordinate system of time t, i.e., the included angle Cy between O′O and x′_{b} in FIG. 2, reflecting the degree to which the aircraft deviates from the desired yaw direction at time t.

It should be pointed out that the above concepts such as the desired yaw angle are described by projecting the geodetic coordinate system to the body coordinate system. Those skilled in the art can understand that the above related concepts may also be defined by projecting the body coordinate system to the geodetic coordinate system. In addition, although the above-mentioned yaw angle is described on the assumption that the direction of the pitch axis of the aircraft is constant for a predetermined period from time t−1 to time t, and the pitch angle is described on the assumption that the direction of the yaw axis of the aircraft is constant for a predetermined period from time t−1 to time t, it should be understood that it is only for convenience of description and not for limitation of the present disclosure.

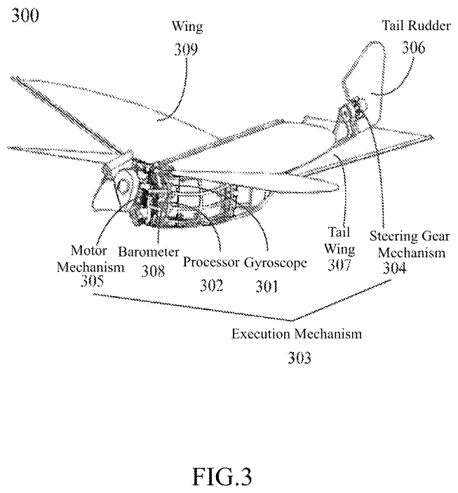

FIG. 3 is a schematic diagram for an aircraft 300 according to an embodiment of the present disclosure. As shown in FIG. 3, the aircraft 300 may include a gyroscope 301, a processor 302 and an execution mechanism 303. These components are connected to each other via buses and/or other connection mechanisms (not shown). The gyroscope 301 is used for measuring an angular velocity of a yaw angle of the aircraft. The processor 302 is used for determining a yaw control signal for the aircraft without considering an acceleration of the aircraft, based on the angular velocity of the yaw angle. The execution mechanism 303 is used for adjusting a flight of the aircraft based on the yaw control signal.

In an embodiment, the aircraft 300 may further include a barometer 308, such as that shown in FIG. 3, for measuring an altitude parameter reflecting the flight altitude of the aircraft. In this embodiment, the gyroscope 301 may further measure an angular velocity of a pitch angle. The processor 302 may further determine an altitude control signal for the aircraft without considering the acceleration of the aircraft, based on the altitude parameter, or based on both the altitude parameter and the angular velocity of the pitch angle measured by the gyroscope. The execution mechanism 303 may further adjust the flight of the aircraft based on the altitude control signal.

In an embodiment, the aircraft 300 is a flapping-wing aircraft. The execution mechanism 303 may include at least one of a steering gear mechanism 304 and a motor mechanism 305 as shown in FIG. 3. In an embodiment, the execution mechanism 303 includes a single-steering-gear mechanism. In another embodiment, the execution mechanism 303 includes a single-motor mechanism. In yet another embodiment, the execution mechanism 303 includes a single-motor-single-steering-gear mechanism. The specific forms of the steering gear mechanism 304 and the motor mechanism 305 are not limited, and any appropriate driving mechanism known in the art and developed in the future may be adopted. For example, the steering gear mechanism 304 may be an electromagnetic steering gear mechanism or the like.

In an embodiment, the aircraft 300 may further include, for example, a tail rudder 306 and a tail wing 307 as shown in FIG. 3, where the tail rudder 306 is connected with the tail wing 307 via the steering gear mechanism 304. In an embodiment of the present disclosure, the steering gear mechanism 304 may adjust the flight of the aircraft through the tail rudder 306 based on the yaw control signal generated by the processor 302. For example, the steering gear mechanism 304 may drive the tail rudder 306 to swing in the yaw axis direction based on the yaw control signal, so as to adjust the flight of the aircraft 300 in the yaw axis direction.

In an embodiment, the aircraft 300 may further include, for example, two pairs of wings 309 as shown in FIG. 3, which are connected with the motor mechanism 305. The motor mechanism 305 may adjust the flight altitude of the aircraft through the wing 308 based on the altitude control signal generated by the processor 302. For example, the motor mechanism 305 may drive the wing 309 to flutter up and down based on the altitude control signal, so as to raise or lower the fuselage of the aircraft 300 to adjust the flight of the aircraft. In an example, the wings 309 may take the form of two pairs of wings, such as an X-wing as shown in FIG. 3. It should be understood that the form and the number of the wings shown in FIG. 3 are merely an example, but not a limitation to the present disclosure.

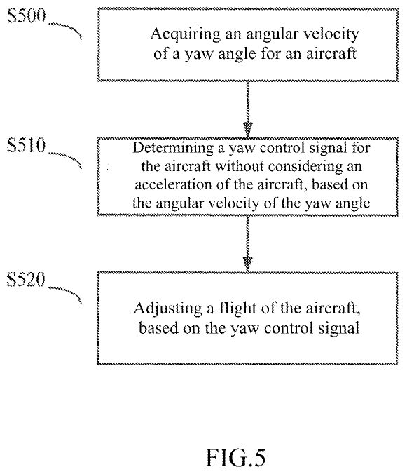

A part of components of the aircraft 300 according to an embodiment of the present disclosure are exemplarily illustrated in conjunction with FIG. 3 above. Operations of the above components will be described in detail later in conjunction with FIGS. 5 to 11.

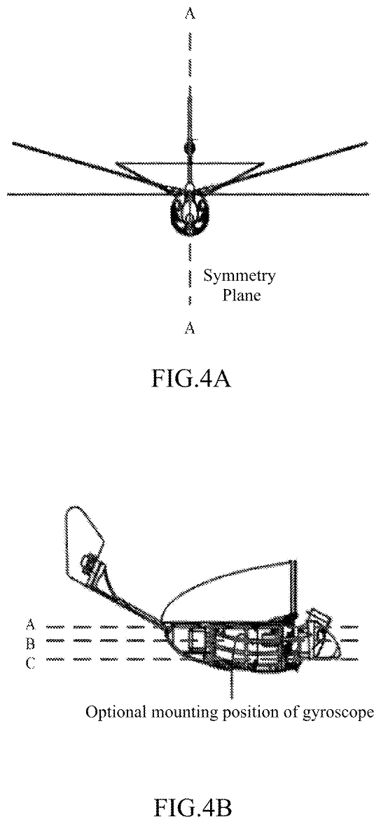

FIGS. 4A and 4B illustrate exemplary mounting positions of gyroscopes on an aircraft according to the embodiments of the present disclosure. FIG. 4A is a front view of an exemplary mounting position of a gyroscope on an aircraft according to an embodiment of the present disclosure; and FIG. 4B is a side view of an exemplary mounting position of a gyroscope on an aircraft according to an embodiment of the present disclosure.

In an embodiment, the gyroscope may be mounted on the symmetry plane of the aircraft, as shown by the dotted line A-A in FIG. 4A. By mounting the gyroscope on the symmetry plane of the aircraft, the weight of the aircraft is distributed more uniformly, so that the angular velocities of individual axes of the aircraft may be measured more accurately. In an embodiment of the present disclosure, the gyroscope may be mounted at any suitable position on the symmetry plane of the aircraft, e.g., at any position on any of multiple axes (e.g., axes A, B and C as shown in FIG. 4B) along the fuselage direction on the symmetry plane. It should be understood that the mounting positions of the gyroscopes shown in FIGS. 4A and 4B are merely examples. Those skilled in the art can understand that gyroscopes may also be mounted at other suitable positions on the aircraft, depending on factors such as mounting positions of various components in the aircraft.

Likewise, in an embodiment, a barometer may be similarly mounted on the symmetry plane of the aircraft. In other embodiments of the present disclosure, the barometer may be mounted at other suitable positions on the aircraft, depending on factors such as the mounting positions of various components in the aircraft.

In the above, the present disclosure illustrates an example of an aircraft according to an embodiment of the present disclosure in conjunction with FIG. 3, and illustrates examples of mountable positions of a gyroscope and a barometer according to an embodiment of the present disclosure in conjunction with FIGS. 4A and 4B. It should be understood, however, that the above-mentioned embodiments are merely examples, but not limitations to the present disclosure. The aircraft of the embodiment of the present disclosure may also be, for example, an aircrafts of other suitable forms such as fixed wing, especially a light aircraft.

The flight of the aircraft according to an embodiment of the disclosure can be more stable, with the operability of the aircraft improved, the manipulation difficulty for the operator reduced, and the experience of the user enhanced.

Furthermore, in the aircraft according to an embodiment of the present disclosure, the integrated accumulated error for the gyroscope may be eliminated or reduced, and the elimination or reduction of the integrated accumulated error does not require the complementary filtering based on acceleration data. Therefore, an aircraft for which the acceleration data of the aircraft is difficult to be used for complementary filtering can also fly stably, which is especially useful for a flapping-wing aircraft (especially a single-tail rudder/single-motor flapping-wing aircraft). Because a flapping-wing aircraft cannot hover, with its steering gear either on the left or on the right, and its both sides cannot be guaranteed as completely consistent when it isn't turning, due to the restricted wing technology, its motion mode is often in a circular motion state. Because the centripetal force other than the gravity continues to act, it is impossible to use acceleration data of the aircraft to calculate an attitude angle to compensate the integrated accumulated error for the gyroscope. This problem is more prominent in terms of a flapping-wing aircraft with a single steering gear/single motor. The aircraft according to an embodiment of the present disclosure can implement a stable flight without acceleration data of the aircraft, thus solving a difficult control problem caused by the inherent characteristics of the aircraft.

Hereinafter, the present disclosure will illustrate a control method for an aircraft according to the embodiments of the present disclosure in detail in conjunction with FIGS. 5 to 11.

FIG. 5 is an example flowchart for a control method for an aircraft according to an embodiment of the present disclosure. As shown in FIG. 5, the control method for the aircraft according to an embodiment of the present disclosure starts with step S500.

At step S500, an angular velocity of a yaw angle of an aircraft is acquired, and the angular velocity of the yaw angle is measured by a gyroscope (e.g., gyroscope 301 in FIG. 3). For example, the gyroscope may be a single-axis gyroscope or a three-axis gyroscope.

In an embodiment, in order to make the measurement result of the gyroscope more accurate, an zero-bias calibration may be performed on the gyroscope to reduce the effect of the static bias of the gyroscope itself on the data. In an embodiment, the zero-bias calibration may be performed on the gyroscope by means of the following method. Assuming that the gyroscope is a three-axis gyroscope, when the three-axis data of the gyroscope is less than a predetermined value (e.g., 100 dps) for a predetermined period (e.g., 20 s) continuously, the gyroscope is considered to be in a stationary state, and then the gyroscope data at this time is recorded. At each subsequent measurement, the result of subtracting the numerical value of the gyroscope in the stationary state recorded as described above from the data measured by the gyroscope is taken as the actual angular velocity.

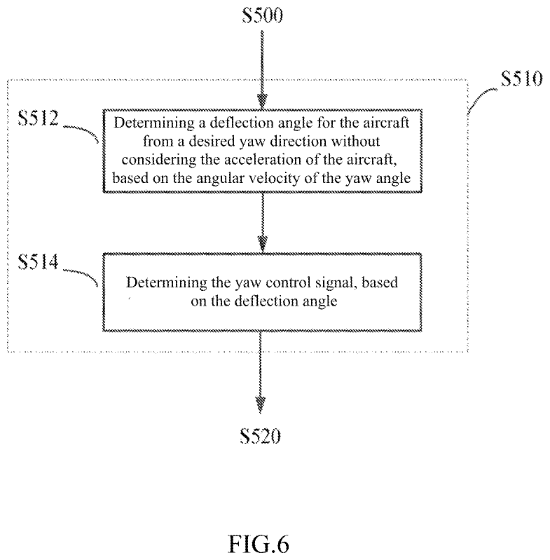

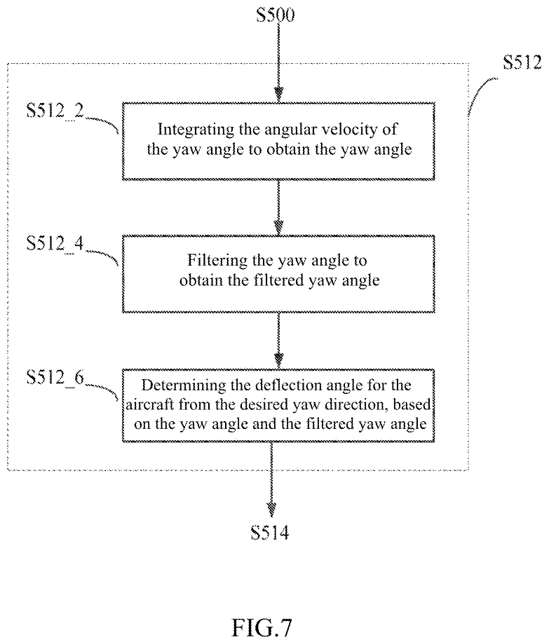

The method then proceeds to step S510. At step S510, a yaw control signal for the aircraft is determined without considering an acceleration of the aircraft, based on the angular velocity of the yaw angle, which will be described in detail later in conjunction with FIGS. 6 and 7. After the yaw control signal is obtained, the method proceeds to step S520. At step S520, a flight of the aircraft is adjusted based on the yaw control signal.

The control method for the aircraft according to the embodiments of the present disclosure described in conjunction with FIG. 5, may adjust a yaw flight of an aircraft without considering acceleration of the aircraft based on an angular velocity of a yaw angle measured by a gyroscope, making it more stable for the yaw flight of the aircraft, especially for a yaw flight of a flapping-wing aircraft.

FIG. 6 is an example flowchart further illustrating determining a yaw control signal for an aircraft without considering an acceleration of the aircraft based on an angular velocity of a yaw angle in FIG. 5 (i.e., step S510), which starts with step S512. At step S512, a deflection angle for the aircraft from a desired yaw direction is determined without considering the acceleration of the aircraft, based on the angular velocity of the yaw angle.

Thereafter, the method proceeds to step S514. At step S514, a yaw control signal is determined based on the deflection angle. For example, the yaw control signal may be determined based on the obtained deflection angle by means of a closed-loop control method, for example, a closed-loop control method with a negative feedback effect such as PID, PI or PD.

In an embodiment, force and direction of a steering gear for controlling the flight of the aircraft, i.e., the yaw control signal, may be output by performing PID control on the deflection angle. Exemplarily, that force of the steering gear may be obtained by equation (1),

Fs=Kp*Cy+Ki*∫Cy*dt+Kd*dCy/dt (1)

where Fs represents the force of the steering gear for controlling the flight of the aircraft, Cy represents the deflection angle for the aircraft from the desired yaw direction, ∫Cy*dt represents an integral operation performed on Cy, dCy/dt represents a differential operation performed on Cy, and Kp, Ki and Kd are constants. In an embodiment, Kp=1, Ki=0.001, and Kd=0.1. It should be noted that values of Kp, Ki and Kd in foregoing embodiments are merely examples, but not limitations. Those skilled in the art may make appropriate settings according to requirements on parameters and control accuracy of the aircraft.

In this case, the larger Cy is, the greater the deflection angle for the aircraft from the desired yaw direction is, that is, the greater the degree to which the aircraft deviates from the desired yaw direction is. When Cy is large, that is, the degree to which the aircraft deviates is large at a certain time point, the deviation of the aircraft can be corrected by means of the control method based on the above equation (1), especially the first item in equation (1), namely Kp*Cy. When the accumulated Cy increases, that is, the deviation degree that the aircraft accumulates for a certain period is large, the accumulated error can be reduced by means of the control method based on the above equation (1), especially the second term in equation (1), i.e. Ki*∫Cy*dt. When Cy changes rapidly in a short period, that is, the aircraft deviates sharply, the deviation of the aircraft can be rapidly corrected by means of the control method based on the above equation (1), especially the third item in equation (1), namely Kd*dCy/dt. As such, various deviation modes of the aircraft can be adjusted accordingly by controlling in the above-mentioned manner.

With respect to the direction of the steering gear, in an embodiment, the direction of the steering gear may be determined based on Cy, for example, if Cy>0, the steering gear is steered in the direction along which Cy is decreasing; if Cy<0, the steering gear is steered in the direction along which Cy is increasing. It should be understood that the aforementioned method of determining the direction of the steering gear is merely an example, but not a limitation to the present disclosure.

In addition to making the flight of the aircraft more stable, the control method for the aircraft described above in conjunction with FIG. 6 may implement various flights of the aircraft (such as a straight flight, a hovering flight, a spiral flight, etc.) by setting an appropriate desired yaw direction, since it is based on the deflection angle for the aircraft from the desired yaw direction, which not only simplifies the operator's operation, but also enriches the operator's experience compared with a single mode only for a straight flight.

With respect to determining the deflection angle for the aircraft from the desired yaw direction (i.e., step S512 in FIG. 6), in an embodiment, the yaw angle may be obtained by integrating the angular velocity of the yaw angle. Then, the deflection angle for the aircraft from the desired yaw direction is determined according to equation (2).

Cy=Ay−θ (2)

where Cy represents the deflection angle for the aircraft from the desired yaw direction, Ay represents the yaw angle, and θ represents the desired yaw angle.

In this embodiment, various flights of the aircraft may be implemented by setting an appropriate θ. For example, setting θ to 0 may implement a straight flight of the aircraft; setting θ to a non-zero constant value may implement a hovering flight of the aircraft, and the like.

Compared with the control method for the aircraft described in conjunction with FIG. 6, the above embodiment obtains the yaw angle by integrating the angular velocity of the yaw angle, which may eliminate or reduce process noise, making the flight of the aircraft more stable. This is because wing flapping of a flapping-wing aircraft is an advance and return movement, and upon the end of one flapping, the wings will return to their original positions. Therefore, by directly integrating the angular velocity of the yaw angle, the process noise generated during one cycle of the wing flapping may be offseted.

With respect to step S512 in FIG. 6, in the above embodiment, the yaw angle is directly obtained by integrating the angular velocity of the yaw angle. In another embodiment, the deflection angle may be determined according to the flow shown in FIG. 7. The method of determining the deflection angle for the aircraft from the desired yaw direction shown in FIG. 7 starts with step S512_2.

At step S512_2, the angular velocity of the yaw angle is integrated to obtain the yaw angle. Then, the method proceeds to step S512_4. At step S512_4, the yaw angle is filtered to obtain the filtered yaw angle. For example, the filtering may be performed by obtaining a difference between the yaw angle of the current time point and the filtered yaw angle of the previous time point and being based on the difference. In an embodiment, a low-pass filter, such as IIR low-pass filter, may be used to filter the yaw angle. In an example embodiment, an IIR low-pass filter with a cut-off frequency of 5 Hz-20 Hz may be used to filter the yaw angle to obtain the filtered yaw angle. It should be understood that filter types and cut-off frequencies in the foregoing embodiments are merely examples, but not limitations. One skilled in the art may choose a suitable filter and set a corresponding cut-off frequency according to the type of aircraft, the flapping of its wings and the like.

After the yaw angle and the filtered yaw angle are obtained, the method proceeds to step S512_6. At step S512_6, the deflection angle for the aircraft from the desired yaw direction is determined based on the yaw angle and the filtered yaw angle. In an embodiment, the deflection angle for the aircraft from the desired yaw direction may be determined according to equation (3),

Cy=Ay−By−θ (3)

where Cy represents the deflection angle for the aircraft from the desired yaw direction, Ay represents the yaw angle, By represents the filtered yaw angle, and θ represents the desired yaw angle.

In an embodiment of the present disclosure, the integrated accumulated error for the gyroscope can be eliminated or reduced by obtaining the difference between the yaw angle (i.e., the integration result of the angular velocity measured by the gyroscope) and the filtered yaw angle, making the flight of the aircraft more stable.

Moreover, in the embodiment of the present disclosure, the elimination or reduction of the above-mentioned integrated accumulated error is carried out by integrating the angular velocity measured by the gyroscope first, then performing the filtering based on the filtered data of the previous time point, and then obtaining the difference between the integration result and the filtered data, which is more suitable for an aircraft for which the frequency of the body movement is close to the noise frequency, such as a flapping-wing aircraft. This is because the conventional complementary filtering is usually suitable for an aircraft (e.g., a rotary wing aircraft) whose power source is fan blades driven by a high-frequency motor, for which the noise frequency is quite different from the frequency of the body movement, and the process noise may be eliminated or reduced by directly filtering the data measured by gyroscopes. Whereas for a flapping-wing aircraft, because the frequency of its wing flapping is close to that of the noise of the actual motion, the effective signal may be filtered out if filtering is performed directly on the angular velocity measured by the gyroscope. In the embodiment of the present disclosure, through the above-mentioned processing manner, the integrated accumulated error for the gyroscope may be effectively eliminated or reduced, making the flight of the aircraft more stable.

In the embodiments described above with reference to FIGS. 5 to 7, the yaw control signal is determined based on the deflection angle for the aircraft from the desired yaw direction. In another embodiment of the present disclosure, the yaw control signal may also be determined based on the rate of change in the deflection angle for the aircraft from the desired yaw direction. In an embodiment, the rate of the change in the deflection angle may be determined according to equation (4) or equation (5),

Dy=(Ay−θ)/Ay (4)

Dy=(Ay−By−θ)/Ay (5)

where Dy represents the rate of the change in the deflection angle for the aircraft from the desired yaw direction, Ay represents the yaw angle, By represents the filtered yaw angle, and θ represents the desired yaw angle.

The determination of the yaw control signal based on the rate of change in the deflection angle is similar to the above-mentioned method of the determination of the yaw control signal based on the deflection angle, except that specific numerical values of the control parameters (e.g., Kp, Ki and Kd in the above equation (1)) involved in the closed-loop control may be different. Therefore, the detailed description thereof is omitted here for brevity.

Compared with the determination of the yaw control signal based on the deflection angle, the determination of the yaw control signal based on the rate of the change in the deflection angle may improve the consistency among individual gyroscopes, and reduce the differences in measurement results resulting from the differences among gyroscopes due to the manufacturing accuracy, so that the performance of different aircrafts using the control method for the aircrafts according to an embodiment of the present disclosure are more consistent.

In the above, the present disclosure describes a control method which can adjust a flight of an aircraft according to an embodiment of the present disclosure in conjunction with FIGS. 5 to 7.

In the control method according to the embodiments of the present disclosure, the flight of the aircraft may be more stable, the operability of the aircraft is improved, the manipulation difficulty for the operator is reduced, and the experience of the user is enhanced.

Furthermore, in the control method according to the embodiments of the present disclosure, the integrated accumulated error for the aircraft can be eliminated or reduced, and the elimination or the reduction of the integrated accumulated error does not require the complementary filtering based on acceleration data of the aircraft. Therefore, it provides an effective and stable flight control manner for an aircraft which has difficulties in utilizing acceleration data of the aircraft for complementary filtering, which is especially useful for a flapping-wing aircraft (especially a single-tail-rudder single-motor type of a flapping-wing aircraft).

In addition, in the control method according to the embodiments of the present disclosure, the yaw angle is obtained by integrating the angular velocity measured by the gyroscope. This can eliminate or reduce the process noise, making the flight of the aircraft more stable, which is especially useful for an aircraft with large noise during a cycle (e.g., a flapping-wing aircraft).

Further, in the control method according to the embodiments of the present disclosure, the filtering is performed after integration based on the filtered data of the previous time point, and the difference between the data before filtering and the data after filtering is used as a control quantity. This can eliminate or reduce the integrated accumulated error for the gyroscope, making the flight of the aircraft more stable. It is more suitable for an aircraft for which the body motion frequency is close to the noise frequency, such as a flapping-wing aircraft.

In addition, in the control method according to the embodiments of the present disclosure, a zero-bias calibration may be performed on the gyroscope. This can further reduce the effect of the static deviation of the gyroscope itself on data, making the flight of aircraft more stable.

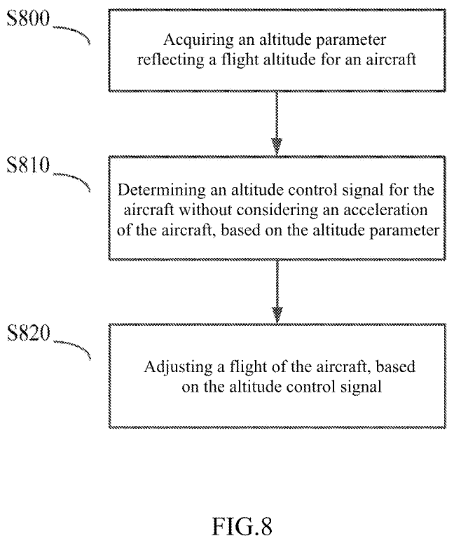

In the above, a control method of adjusting a yaw flight of an aircraft according to the embodiments of the present disclosure is described in conjunction with FIGS. 5 to 7. Hereinafter, the present disclosure will describe a control method which can adjust a pitch flight (i.e., flight altitude) of an aircraft according to the embodiments of the present disclosure in conjunction with FIGS. 8 to 11.

FIG. 8 is another example flowchart for a control method for an aircraft according to an embodiment of the present disclosure. As shown in FIG. 8, the control method for the aircraft according to the embodiment of the present disclosure starts with step S800.

At step S800, an altitude parameter reflecting a flight altitude of an aircraft is acquired. In an embodiment, the altitude parameter may be air pressure, e.g., measured by a barometer. In another embodiment, the altitude parameter may be altitude, e.g, measured by an altimeter. It should be understood that the air pressure and the altitude may be converted to each other. In the present disclosure, the barometer and the altimeter have similar functions, that is, for obtaining parameters that directly or indirectly reflect the flight altitude of the aircraft. In addition, it should also be understood that the air pressure and the altitude in the foregoing embodiments are merely examples of the altitude parameters reflecting the flight altitude of the aircraft, but not limitations thereto.

After the altitude parameter reflecting the flight altitude of the aircraft is obtained, the method proceeds to step S810. At step S810, an altitude control signal for the aircraft is determined without considering acceleration of the aircraft, based on the altitude parameter. In terms of determining the altitude control signal for the aircraft in step S810, the description will be made in detail later. Thereafter, the method proceeds to step S820. At step S820, the flight of the aircraft is adjusted, based on the altitude control signal.

The control method for the aircraft according to the embodiment of the present disclosure described in conjunction with FIG. 8 may adjust the pitch flight of the aircraft without considering the acceleration of the aircraft based on the parameter reflecting the flight altitude measured by the barometer (or altimeter), making the pitch flight of the aircraft, especially the flapping-wing aircraft, more stable.

In terms of determining the altitude control signal for the aircraft without considering the acceleration of the aircraft based on the altitude parameter in step S810, in an embodiment, the altitude control signal for the aircraft may be determined by steps of: calculating a difference between a altitude parameter corresponding to the target altitude and the acquired altitude parameter, and determining the altitude control signal for the aircraft based on the difference.

For example, the difference between the altitude parameter corresponding to the target altitude and the acquired altitude parameter may be calculated according to equation (6),

D=Pe−P (6)

where D is the difference between the altitude parameter corresponding to the target altitude and the acquired altitude parameter, Pe is the altitude parameter corresponding to the target altitude, and P is the acquired altitude parameter.

After the difference D is obtained, the altitude control signal for the aircraft may be determined based on the difference by means of a closed-loop control method, for example, a closed-loop control method with a negative feedback effect such as PID, PI or PD. In an embodiment, the rotational speed of the motor mechanism of the aircraft, i.e., the altitude control signal for the aircraft, may be determined according to equation (7).

M′=M+Kp*D+Ki*∫(D)*dt+Kd*dD/dt (7)

where M′ represents a control quantity output to the motor mechanism, i.e., the rotational speed that the motor mechanism should achieve, M represents the last control quantity, i.e., the current rotational speed of the motor mechanism, ∫(D)*dt represents an integral operation performed on D, dD/dt represents a differential operation performed on D, and Kp, Ki and Kd are constants. In an embodiment, Kp=100, Ki=0.001, and Kd=1. It should be noted that values of Kp, Ki and Kd in the foregoing embodiments are merely examples, but not limitations. Those skilled in the art may make appropriate settings according to requirements on parameters and control accuracy of the aircraft.

In addition, in order to make the altitude parameter more accurate, before the altitude parameter is used to determine the altitude control signal, the acquired altitude parameter may be corrected by a correction parameter. In an embodiment, the altitude parameter may be corrected by equation (8),

P′=P−W (8)

where P′ represents the corrected altitude parameter, P represents the acquired altitude parameter, and W represents the correction parameter, which is a constant related to the barometer or altimeter used by the aircraft, and whose specific numerical value may be appropriately set by those skilled in the art as required, without any limitations herein.

In another embodiment, the altitude parameter may be corrected by equation (9),

P′=P−M*γ (9)

where P′ represents the corrected altitude parameter, P represents the acquired altitude parameter, M is the current rotational speed of the motor mechanism of the aircraft, and γ is an experimental setting parameter, whose specific numerical value may be appropriately set by those skilled in the art as required, without any limitations herein.

Compared with the utilization of a fixed correction parameter to correct the altitude parameter as illustrated by equation (8), the correction method illustrated by equation (9) takes into account the effect of the rotation of the motor mechanism of the aircraft, making the corrected altitude parameters more accurate.

In terms of determining the altitude control signal for the aircraft without considering the acceleration of the aircraft based on the altitude parameter in step S810, in an embodiment, the altitude control signal for the aircraft may be determined by steps of: filtering the altitude parameter to obtain the filtered altitude parameter; calculating the difference between the altitude parameter corresponding to the target altitude and the filtered altitude parameter; and determining the altitude control signal for the aircraft based on the difference. The calculation in this case of the difference between the altitude parameter corresponding to the target altitude and the filtered altitude parameter is the same as the above-mentioned calculation of the difference between the altitude parameter corresponding to the target altitude and the acquired altitude parameter; and the determination in this case of the altitude control signal for the aircraft based on the difference is the same as the above-mentioned determination of the altitude control signal for the aircraft based on the difference. Therefore, the detailed description thereof is omitted here for brevity.

In terms of filtering the altitude parameters to obtain the filtered altitude parameters, in an embodiment, the acquired plurality of altitude parameters may be filtered by equation (10), that is, a moving average filtering with extremum removal is performed on the acquired plurality of altitude parameters,

Pa=(Σᵢ₌₁^{N}ΣP[i]−MAX(P[N])−MIN(P[N]))/(N−2) (10)

where Pa represents the filtered altitude parameter, P[i], i=1 . . . N represents the acquired altitude parameter, N is an integer greater than or equal to 3, MAX(P[N]) represents the maximum value among the N acquired altitude parameters, and MIN(P[N]) represents the minimum value among the N acquired altitude parameters.

Compared with the above-mentioned determination of the altitude control signal based on a directly acquired altitude parameter, the determination of the altitude control signal based on the filtered altitude parameter may remove abnormal values from the acquired altitude parameter, and smooth the acquired altitude parameter, making the altitude parameter for determining the altitude control signal more accurate.

Those skilled in the art can understand that the above-mentioned moving average filtering with extremum removal is merely an example. Those skilled in the art may perform statistical averaging and filtering on the acquired plurality of altitude parameters in other various ways.

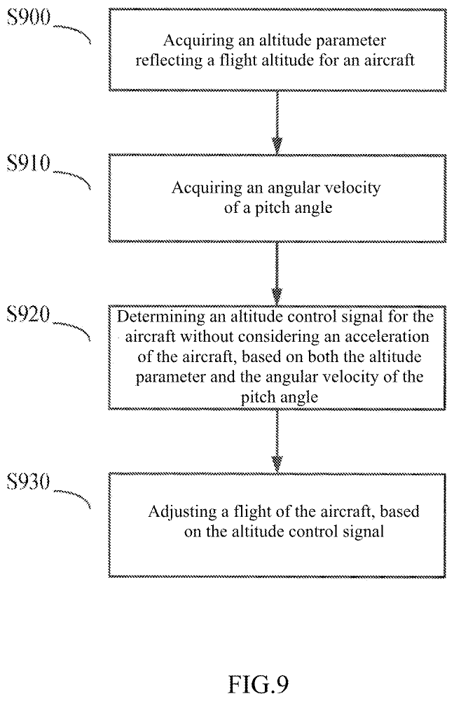

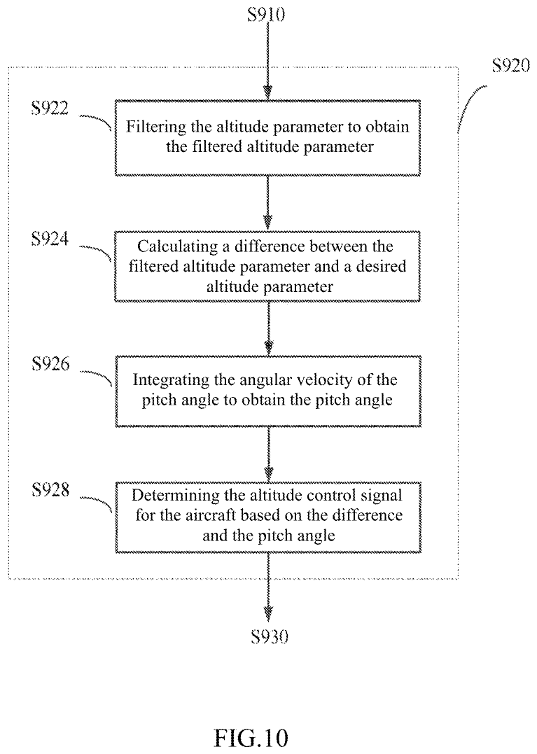

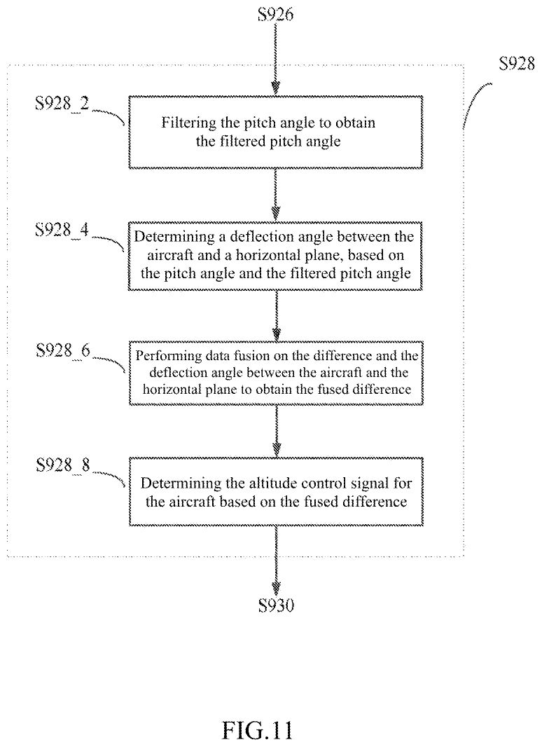

FIG. 9 is another example flowchart for a control method for an aircraft according to an embodiment of the present disclosure. The control method for the aircraft shown in FIG. 9 starts with step S900. At step S900, an altitude parameter reflecting a flight altitude of an aircraft is acquired, which is similar to step S800 in FIG. 8, and the detailed description thereof is omitted here for brevity. Thereafter, the method proceeds to step S910. At step S910, an angular velocity of a pitch angle is acquired, which is similar to step S500 in FIG. 5, and the detailed description thereof is omitted here for brevity. After the altitude parameter and the angular velocity of the pitch angle are acquired, the method proceeds to step S920. At step S920, an altitude control signal for the aircraft is determined without considering an acceleration of the aircraft, based on both the altitude parameter and the angular velocity of the pitch angle. Later, the processing of determining the altitude control signal for the aircraft in step S920 will be described in detail in conjunction with FIGS. 10 and 11. Thereafter, the method proceeds to step S930. At step S930, a flight of the aircraft is adjusted, based on the altitude control signal, which is similar to step S820 in FIG. 8, and the detailed description thereof is omitted here for brevity.

Compared with the control method for the aircraft described in conjunction with FIG. 8, the control method for the aircraft described in conjunction with FIG. 9 determines the altitude control signal for the aircraft based on both the altitude parameter and the angular velocity of the pitch angle, and takes into account the effect of the angular velocity of the pitch angle of the aircraft on the flight altitude of the aircraft, making the pitch flight of the aircraft more stable.

In terms of the determination of the altitude control signal for the aircraft without considering the acceleration of the aircraft based on both the altitude parameter and the angular velocity of the pitch angle in step S920, in an embodiment, the altitude control signal for the aircraft may be determined based on the flow illustrated in FIG. 10. As shown in FIG. 10, in an embodiment of the present disclosure, the method of determining the altitude control signal for the aircraft starts with step S922.

At step S922, the altitude parameter is filtered to obtain the filtered altitude parameter. Thereafter, the method proceeds to step S924. At step S924, a difference between the filtered altitude parameter and a desired altitude parameter is calculated. At step S926, the angular velocity of the pitch angle is integrated to obtain the pitch angle. After the difference and the pitch angle are obtained, the method proceeds to step S928. At step S928, the altitude control signal for the aircraft is determined based on the difference and the pitch angle.

In terms of the processing of determining the altitude control signal for the aircraft in step S928, in an embodiment, the altitude control signal for the aircraft may be determined using the flow illustrated in FIG. 11. As shown in FIG. 11, in an embodiment of the present disclosure, the method of determining the altitude control signal for the aircraft starts with step S928_2.

At step S928_2, the pitch angle is filtered to obtain the filtered pitch angle, which is similar to step S512_4 in FIG. 7, and the detailed description thereof is omitted here for brevity. Thereafter, the method proceeds to step S928_4. At step S928_4, a deflection angle between the aircraft and the horizontal plane is determined, based on the pitch angle and the filtered pitch angle, which will be described in detail later. After the difference and the deflection angle are obtained, the method proceeds to step S928_6. At step S928_6, data fusion is performed on the difference and the deflection angle to obtain the fused difference, which will be described in detail later. Thereafter, the method proceeds to step S928_8. At step S928_8, the altitude control signal for the aircraft is determined based on the fused difference, which is similar to the above-mentioned determination of the altitude control signal for the aircraft based on the difference between the altitude parameter corresponding to the target altitude and the acquired altitude parameter, and the detailed description thereof is omitted here for brevity.

In terms of the determination of the deflection angle between the aircraft and the horizontal plane in step S928_4, in an embodiment, the deflection angle may be determined according to equation (11),

Cz=Az−Bz (11)

where Cz represents the deflection angle between the aircraft and the horizontal plane, Az represents the pitch angle, and Bz represents the filtered pitch angle.

In terms of the data fusion performed on the difference and the deflection angle in step S928_6, in an embodiment, the data fusion may be performed on the difference and the deflection angle using equation (12),

D′=D*a1+Cz*β*a2 (12)

where D′ represents the fused difference; D represents the difference prior to the fusion (e.g., the difference calculated at step S924); a1 and a2 are constants and a1+a2=1; R is a constant reflecting the effect of the deflection angle between the aircraft and the horizontal plane on the altitude parameter, and its unit is (unit of altitude parameter)/(unit of deflection angle). In an embodiment, P=0.5, a1=0.9 and a2=0.1. It should be noted that the values of β, a1, and a2 in the foregoing embodiments are merely examples, but not limitations. Those skilled in the art may make appropriate settings according to requirements on the parameters and control accuracy of the aircraft.

In addition, in an embodiment of the present disclosure, in addition to that the data fusion may be performed on the difference and the deflection angle between the aircraft and the horizontal plane to obtain the fused difference, the data fusion may be performed on the difference and the deflection angle between the aircraft and the desired pitch direction to obtain the fused difference, meaning that, in the pitch axis direction, the control is affected only when the angle of the head of the aircraft changes to a certain degree.

In addition, similar to the above-mentioned determination of the yaw control signal, in addition to that the pitch control signal may be determined based on the deflection angle between the aircraft and the horizontal plane, in an embodiment of the present disclosure, the pitch control signal may be determined based on a rate of change in the deflection angle between the aircraft and the horizontal plane. The determination of the rate of change in the deflection angle between the aircraft and the horizontal plane is similar to the determination of the rate of change in the deflection angle between the aircraft and a desired yaw direction, and the detailed description thereof is omitted here for brevity.

In addition, it should be noted that the above-mentioned steps of determining the altitude control signal for the aircraft based on both the altitude parameter and the angular velocity of the pitch angle in FIGS. 9 and 10 are not completely necessary. In an embodiment, step S922 may be omitted, that is, the altitude parameter difference is determined using the acquired altitude parameter directly. In an embodiment, step S928_2 may be omitted, that is, the deflection angle between the aircraft and the horizontal plane is determined using the pitch angle directly.

In the above, the present disclosure describes a control method which can adjust a yaw flight of an aircraft according to embodiments of the present disclosure in conjunction with FIGS. 5 to 7; and describes a control method which can adjust a pitch flight (i.e., flight altitude) of an aircraft according to embodiments of the present disclosure in conjunction with FIGS. 8 to 11. It should be understood that although the control method for controlling the yaw flight of the aircraft and the control method for controlling the pitch flight of the aircraft are separately described in the above, the embodiments of both methods may be combined with each other. That is, the control method for the aircraft according to the embodiments of the present disclosure may generate the yaw control signal for the aircraft based on the angular velocity of the yaw angle measured by the gyroscope, and may generate the pitch control signal for the aircraft based on the altitude parameter reflecting the flight altitude of the aircraft measured by a barometer (or an altimeter), or based on both the altitude parameter and the angular velocity of the pitch angle measured by the gyroscope, without considering an acceleration of the aircraft, thereby simultaneously controlling the yaw flight and the pitch flight of the aircraft and achieving a stable flight of the aircraft. In terms of the stable flight of the aircraft, in the present disclosure, it means that the deviation between the actual flight trajectory and the desired flight trajectory of the aircraft is within a certain range.

In the above, the present disclosure describes an aircraft according to embodiments of the present disclosure in conjunction with FIGS. 3 to 4B, and describes a control method for an aircraft according to embodiments of the present disclosure in conjunction with FIGS. 5 to 11. In order for a clearer illustration of the flight of the aircraft under the control of the control method for the aircraft according to the embodiments of the present disclosure, hereinafter, the present disclosure will give example flight trajectories of the aircraft under the control of the control method for the aircraft according to the embodiments of the present disclosure in conjunction with FIGS. 12 and 13.

FIG. 12 shows an example flight trajectory of an aircraft under the control of the control method for the aircraft according to an embodiment of the present disclosure. When a desired yaw angle θ is set to 0, for example, 0 in the above equation (3) is set to 0, and a desired flight altitude is fixed, a stable straight flight as shown in FIG. 12 may be achieved, where OQ is a desired flight trajectory and OP is an actual flight trajectory of the aircraft.

As described above, in the present disclosure, the stable flight of the aircraft means that the deviation between the actual flight trajectory and the desired flight trajectory of the aircraft is within a certain range. Therefore, the stable straight flight of the aircraft as shown in FIG. 12 means that the deviation between the actual flight trajectory OP and the desired flight trajectory OQ of the aircraft is within a threshold range. The offset of the flight trajectory may be calculated only based on the offset of the end point, or based on the offsets of a plurality of predetermined midway points during the flight, or based on the offsets of a plurality of predetermined time points during the flight, and so on. The offset may be an absolute or relative offset. The threshold range may be appropriately set by those skilled in the art depending on the specific approach of calculating the offset, the parameters of the aircraft, etc., without any limitations herein.

FIG. 13 shows another example flight trajectory of an aircraft under the control of the control method for the aircraft according to an embodiment of the present disclosure. When a desired yaw angle θ is set to a non-zero constant, for example, θ in the above equation (3) is set to a non-zero constant, and a desired flight altitude is fixed, a stable hovering flight as shown in FIG. 13 may be achieved, where 1310 is a desired flight trajectory and 1320 is an actual flight trajectory of the aircraft 1300.

It should be understood that the above flight trajectories shown in FIGS. 12 and 13 are merely examples, but not limitations. Various kinds of flights, such as the splay flight, the spiral flight and the elliptical flight, may be achieved by appropriately setting the desired yaw direction (i.e., the desired yaw angle θ) and/or the flight altitude.

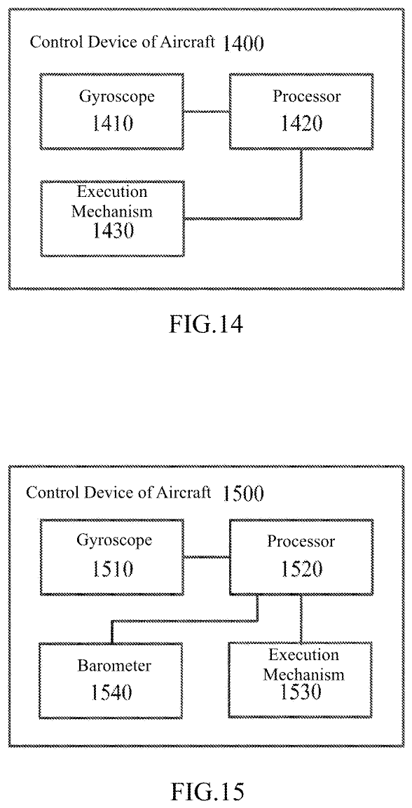

In the above, the present disclosure describes an aircraft according to embodiments of the present disclosure in conjunction with FIGS. 3 to 4B, describes a control method for an aircraft according to embodiments of the present disclosure in conjunction with FIGS. 5 to 11, and describes some example flight trajectories of an aircraft under the control of the control method for the aircraft according to embodiments of the present disclosure in conjunction with FIGS. 12 and 13. Hereinafter, the present disclosure will describe a control device of an aircraft according to embodiments of the present disclosure in conjunction with FIGS. 14 and 15.

FIG. 14 is an example block diagram for a control device of an aircraft according to an embodiment of the present disclosure. As shown in FIG. 14, a control device 1400 of an aircraft according to an embodiment of the present disclosure may include a gyroscope 1410 for measuring an angular velocity of a yaw angle, a processor 1420 for performing a control method for an aircraft according to an embodiment of the present disclosure described in conjunction with FIGS. 5 to 7, and an execution mechanism 1430 for adjusting a flight of an aircraft based on a control signal generated by the processor 1420.

FIG. 15 is another example block diagram for a control device of an aircraft according to an embodiment of the present disclosure. As shown in FIG. 15, a control device 1500 of an aircraft according to an embodiment of the present disclosure may include a gyroscope 1510 for measuring at least one of an angular velocity of a yaw angle and an angular velocity of a pitch angle, a processor 1520 performing a control method for an aircraft according to an embodiment of the present disclosure described in conjunction with FIGS. 5 to 11, an execution mechanism 1530 for adjusting a flight of an aircraft based on a control signal generated by the processor 1520, and a barometer (or an altimeter) 1540 for measuring an altitude parameter reflecting a flight altitude of an aircraft.

It should be understood that connection modes for individual components of the control device of the aircraft according to the embodiments of the present disclosure shown in FIGS. 14 and 15 are merely examples, but not limitations to the present disclosure. Depending on factors such as mounting positions of the individual components in the aircraft, those skilled in the art may appropriately connect the individual components shown in FIGS. 14 and 15 as required. In addition, the present disclosure further provides a control device of an aircraft, comprising: a processor; memory; and computer program instructions stored in the memory which, when being executed by the processor, performs steps of the control method for the aircraft according to any embodiment of the present disclosure.

In addition, the present disclosure further provides a computer-readable storage medium storing a computer program thereon which, when being executed by a processor, implements the control method for the aircraft according to any embodiment of the present disclosure.

So far, the present disclosure has described the aircraft, the control method for the aircraft, the control device of the aircraft and the computer-readable storage medium according to the embodiments of the present disclosure in conjunction with the accompanying drawings, which utilize gyroscopes or both gyroscopes and barometers (or altimeters) to identify the flight attitude of the flapping-wing aircraft by means of a unique filtering method, so as to achieve a self-stable flight of the aircraft. Therefore, the problem that the existing flapping-wing aircraft, especially the flapping-wing aircraft with single tail rudder and single motor, cannot achieve a self-stable flight based on acceleration data of the aircraft, is solved.

It should be noted that the above description is only some embodiments of the present disclosure and an illustration of the applied technical principles. It should be understood by those skilled in the art that the disclosure scope involved in the present disclosure is not limited to the technical solutions resulted from specific combinations of the above technical features, but also encompasses other technical solutions resulted from any combination of the above technical features or their equivalents without departing from the above disclosed concept, for example, the technical solutions formed by replacing between the above features and the technical features with similar functions disclosed in the present disclosure (but not limited thereto).

In addition, although the operations are depicted in a specific order, this should not be understood as requiring these operations to be performed in the specific order shown or in a sequential order. In certain circumstances, multitasking and parallel processing may be beneficial. Likewise, although several specific implementation details are included in the above discussion, these should not be interpreted as limiting the scope of the present disclosure. Some features described in the context of separate embodiments can also be implemented in a single embodiment in combination. On the contrary, various features described in the context of a single embodiment can also be implemented in multiple embodiments alone or in any suitable sub-combination.

Although the subject matter has been described in a language specific to structural features and/or logical acts of methods, it should be understood that the subject matter defined in the appended claims is not necessarily limited to the specific features or acts described above. On the contrary, the specific features and actions described above are merely example forms of implementing the claims.

This application claims the priority of Chinese patent application No. 202010380801.0 filed on May 6, 2020, and the contents disclosed in the above Chinese patent application are cited in its entirety as a part of this application.

1. An aircraft, comprising:
a gyroscope, for measuring an angular velocity of a yaw angle for the aircraft;
a processor, for determining a yaw control signal for the aircraft without considering an acceleration of the aircraft based on the angular velocity of the yaw angle; and
an execution mechanism, for adjusting a flight of the aircraft based on the yaw control signal.

2. The aircraft according to claim 1, wherein determining the yaw control signal for the aircraft comprises:
determining a deflection angle for the aircraft from a desired yaw direction or a rate of change in the deflection angle without considering the acceleration of the aircraft, based on the angular velocity of the yaw angle, and
determining the yaw control signal, based on the deflection angle or the rate of change in the deflection angle.

3. The aircraft according to claim 2, wherein determining the deflection angle for the aircraft from the desired yaw direction or the rate of change in the deflection angle comprises:
integrating the angular velocity of the yaw angle to obtain the yaw angle; and
determining the deflection angle for the aircraft from the desired yaw direction or the rate of change in the deflection angle, based on the yaw angle.

4. The aircraft according to claim 3, wherein determining the deflection angle for the aircraft from the desired yaw direction or the rate of change in the deflection angle based on the yaw angle comprises:
filtering the yaw angle to obtain the filtered yaw angle;
determining the deflection angle for the aircraft from the desired yaw direction or the rate of change in the deflection angle, based on the yaw angle and the filtered yaw angle.

5. The aircraft according to claim 2, wherein determining the yaw control signal based on the deflection angle or the rate of change in the deflection angle comprises:
determining the yaw control signal by a closed-loop control method, based on the deflection angle or the rate of change in the deflection angle.

6. (canceled)

7. The aircraft according to claim 1, further comprising: a tail wing and a tail rudder,
wherein the execution mechanism comprises a steering gear mechanism, and the tail rudder is connected with the tail wing via the steering gear mechanism; and
wherein the steering gear mechanism is configured to adjust the flight of the aircraft through the tail rudder based on the yaw control signal.

8. The aircraft according to claim 1, further comprising:
a barometer, for measuring an altitude parameter reflecting a flight altitude for the aircraft;
wherein, the gyroscope is further used for measuring an angular velocity of a pitch angle;
the processor is further used for determining an altitude control signal for the aircraft without considering the acceleration of the aircraft, based on the altitude parameter, or both the altitude parameter and the angular velocity of the pitch angle measured by the gyroscope; and
the execution mechanism is further used for adjusting the flight of the aircraft based on the altitude control signal.

9. The aircraft according to claim 8, wherein determining the altitude control signal for the aircraft based on the altitude parameter comprises:
filtering the altitude parameter to obtain the filtered altitude parameter;
calculating a difference between the filtered altitude parameter and a desired altitude parameter; and
determining the altitude control signal for the aircraft based on the difference.

10. The aircraft according to claim 8, wherein determining the altitude control signal for the aircraft based on both the altitude parameter and the angular velocity of the pitch angle measured by the gyroscope comprises:
filtering the altitude parameter to obtain the filtered altitude parameter;
calculating a difference between the filtered altitude parameter and a desired altitude parameter;
integrating the angular velocity of the pitch angle to obtain the pitch angle; and
determining the altitude control signal for the aircraft based on the difference and the pitch angle.

11. The aircraft according to claim 10, wherein determining the altitude control signal for the aircraft based on the difference and the pitch angle comprises:
filtering the pitch angle to obtain the filtered pitch angle;
determining a deflection angle between the aircraft and a horizontal plane or a rate of change in the deflection angle, based on the pitch angle and the filtered pitch angle;
performing data fusion on the difference and the deflection angle between the aircraft and the horizontal plane, or on the difference and the rate of change in the deflection angle between the aircraft and the horizontal plane, to obtain the fused difference; and
determining the altitude control signal for the aircraft based on the fused difference.

12. The aircraft according to claim 8, wherein the altitude parameter measured by the barometer is corrected by a correction parameter before being used for determining the altitude control signal.

13. The aircraft according to claim 8, further comprising a wing,
wherein, the execution mechanism comprises a motor mechanism which is connected with the wing; and
wherein the motor mechanism is configured to adjust the flight of the aircraft through the wing based on the altitude control signal.

14. The aircraft according to claim 1, wherein the aircraft is a flapping-wing aircraft, and the execution mechanism comprises at least one of a single-steering-gear mechanism and a single-motor mechanism.

15. The aircraft according to claim 14, wherein the aircraft comprises a fuselage, and the gyroscope is located on a central axis in a direction of the fuselage.

16. A control method for an aircraft, comprising:
acquiring an angular velocity of a yaw angle for the aircraft;
determining a yaw control signal for the aircraft without considering an acceleration of the aircraft, based on the angular velocity of the yaw angle; and
adjusting a flight of the aircraft, based on the yaw control signal.

17. The control method for the aircraft according to claim 16, wherein determining the yaw control signal for the aircraft comprises:
determining a deflection angle for the aircraft from a desired yaw direction or a rate of change in the deflection angle without considering the acceleration of the aircraft, based on the angular velocity of the yaw angle, and
determining the yaw control signal, based on the deflection angle or the rate of change in the deflection angle.

18. The control method for the aircraft according to claim 17, wherein determining the deflection angle for the aircraft from the desired yaw direction or the rate of change in the deflection angle comprises:
integrating the angular velocity of the yaw angle to obtain the yaw angle; and
determining the deflection angle for the aircraft from the desired yaw direction or the rate of change in the deflection angle, based on the yaw angle.

19. The control method for the aircraft according to claim 18, wherein determining the deflection angle for the aircraft from the desired yaw direction or the rate of change in the deflection angle based on the yaw angle comprises:
filtering the yaw angle to obtain the filtered yaw angle;
determining the deflection angle for the aircraft from the desired yaw direction or the rate of change in the deflection angle, based on the yaw angle and the filtered yaw angle.

20-21. (canceled)

22. The control method for the aircraft according to claim 16, further comprising:
acquiring an altitude parameter reflecting a flight altitude for the aircraft;
acquiring an angular velocity of a pitch angle;
determining an altitude control signal for the aircraft without considering the acceleration of the aircraft, based on the altitude parameter, or both the altitude parameter and the angular velocity of the pitch angle;
adjusting the flight of the aircraft, based on the altitude control signal.

23-26. (canceled)

27. A computer-readable storage medium storing a computer program thereon which, when being executed by a processor, implements the method according to claim 16.
